(19) United States
(12) Patent Application Publication
(10) Pub. No.: US 2013/0335313 A1
(43) Pub. Date: Dec. 19, 2013

(54) PROCESS OF CREATING A DISPLAY, SYSTEM FOR CREATING A DISPLAY, AND MOBILE UNTETHERED DISPLAY DEVICE

(71) Applicants: Adam DAVIS, Leola, PA (US); Frederic Frank OPSOMER, Kortemark (BE)

(72) Inventors: Adam DAVIS, Leola, PA (US); Frederic Frank OPSOMER, Kortemark (BE)

(73) Assignee: TAIT TECHNOLOGIES, INC., Waardamme (BE)

(21) Appl. No.: 13/570,701

(22) Filed: Aug. 9, 2012

(30) Foreign Application Priority Data
Jun. 19, 2012 (BE) 2012/0409

(51) Int. Cl. G09G 5/00; G06F 3/01

(52) U.S. Cl. 345/156; 345/1.3; 345/168

(57) ABSTRACT

A process of creating a display, a system for creating a display, and a mobile untethered display device are disclosed. The process includes providing image data to a first spectator display device, providing image data to a second spectator display device, and activating at least one of one or more light emitting elements based upon the image data. The first spectator display device includes one or more of the light emitting elements. The first spectator display device is a mobile untethered device positioned within a spectator region of a venue and creates a display having an illusion of a continuous image. The system includes a first spectator display device, a second spectator display device, and a controller. The device includes one of one or more light emitting elements capable of being activated upon receiving image data corresponding with a portion of the display.

### FIELD OF THE INVENTION

The present invention is directed to display devices, display systems, and display processes. More specifically, the present invention is directed to light emitting mobile devices, systems, and display processes.

### BACKGROUND OF THE INVENTION

It is well known that an illusion of larger image can be created by aligning a plurality of cards, such as is done in the formation of a mosaic. This concept has been employed in stadiums to produce images within a spectator portion of the stadium. For example, in one known display of these cards, each card was a rigid flat panel including a printed image that is a portion of a larger image to be assembled. The spectators received assigned cards corresponding to their seats in the stadium. Such printed displays have substantial limitations with regard to brightness or resolution. Furthermore, such printed displays are not capable of displaying sequences of moving images, and cannot be used quickly to display real-time data.

Known electronic display screens have been used in stadiums for display of enlarged digital images, particularly for advertising on billboards and similar structures. These electronic display screens suffer from the drawback of requiring externally supplied central power and/or consolidated control. Also, these electronic display screens do not foster interactive participation in the display by the spectator crowd.

A mobile untethered display device, a system for creating a display, and a process of creating a display, that do not suffer from one or more of the above drawbacks would be desirable in the art.

### BRIEF DESCRIPTION OF THE INVENTION

In an exemplary embodiment, a process of creating a display having an illusion of a continuous image includes providing image data to a first spectator display device, the first spectator display device including one or more light emitting elements, providing image data to a second spectator display device, and activating at least one of the one or more light emitting elements based upon the image data. The first spectator display device is a mobile untethered device positioned within a spectator region of a venue.

In another exemplary embodiment, a system for creating a display having an illusion of a continuous image includes a first spectator display device is a mobile untethered device including one or more light emitting elements, a second spectator display device, and a controller capable of providing image data to one or both of the first spectator display device and the second spectator display device. At least one of the one or more light emitting elements is capable of being activated based upon the image data. At least a portion of the first spectator display device is positioned within a spectator region of a venue.

In another exemplary embodiment, a spectator display device for creating a display in a venue includes one or more light emitting elements capable of being activated upon receiving image data. The spectator display device is positioned within a spectator region of the venue and the image data corresponds with a portion of the display.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary display at a venue according to the disclosure.

FIG. 2 is an enlarged perspective view of an exemplary display in a spectator region showing spectator positions according to the disclosure.

FIG. 3 is a perspective view showing a portion of an exemplary seat-mounted display according to the disclosure.

FIG. 4 is a front view showing a portion of an exemplary spectator-mounted display according to the disclosure.

FIG. 5 is a perspective front view of an exemplary spectator display device according to the disclosure.

FIG. 6 is a schematic of an exemplary display system according to the disclosure.

Wherever possible, the same reference numbers will be used throughout the drawings to represent the same parts.

### DETAILED DESCRIPTION OF THE INVENTION

Provided is a mobile untethered display device, a system for creating a display, and a process of creating a display. Embodiments of the present disclosure create an illusion of a continuous image, create an illusion of three-dimensional objects or images, provide a higher quality graphic display with the desired level of brightness and resolution of an enlarged digital image (in comparison to printed display cards), permit still and/or moving images to be displayed as an array within a spectator region of a venue, foster spectator participation in creating an arrayed display, and permit display of complex image sequences through independent control of hand-held electronic display devices, or combinations thereof.

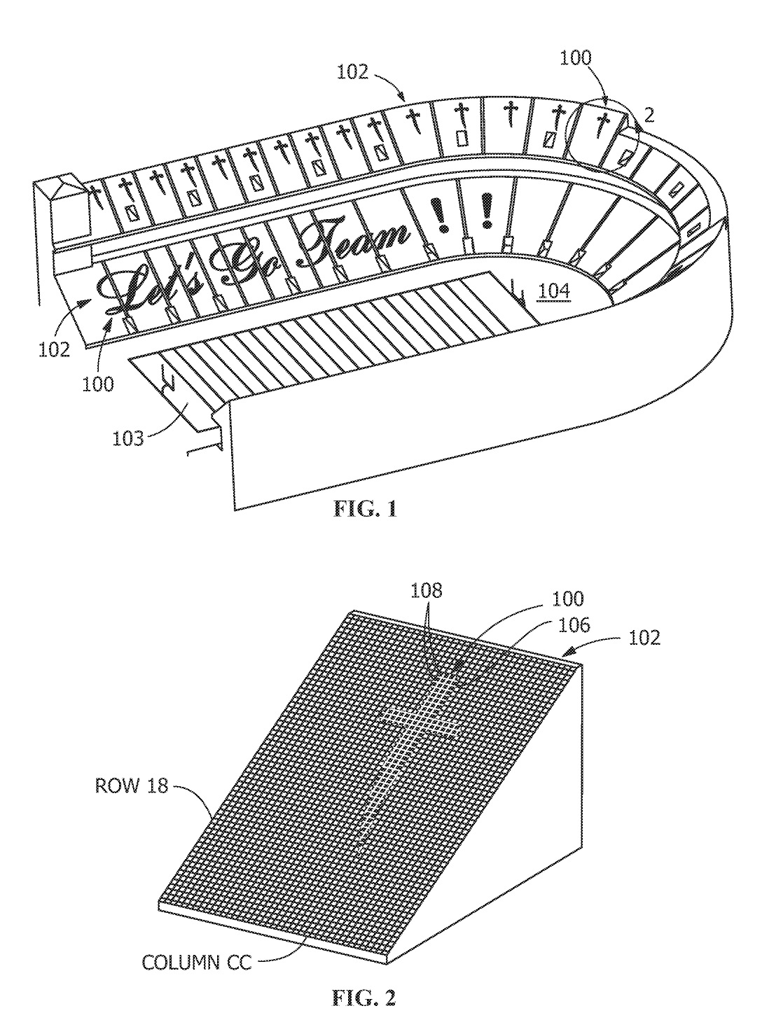

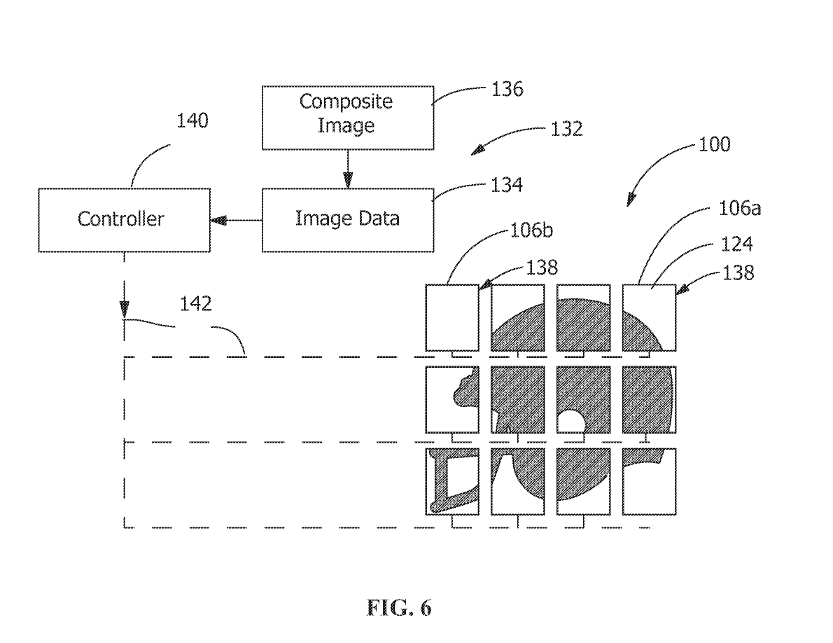

According to an embodiment, FIGS. 1 and 2 show a display 100 within a spectator region 102 of a venue 104 (for example, with a system 132 including a controller 140 operable as part of a tracking system as is further shown and described below with reference to FIG. 6). The display 100 includes a plurality of spectator display devices 106 arranged and disposed within the spectator region 102, in contrast to a non-spectator region 103, such as a playing field, performance stage, dugouts or other player area, band or orchestra area, media/announcer area, concessions, ticket or merchandizing area, or parking lots.

At least a portion of the spectator positions 108 includes one or more of the spectator display devices 106. In one embodiment, each spectator display device 106 is electronically assigned the corresponding spectator position 108 display coordinates within an array map. In one embodiment, the tracking system is used to electronically detect or tag and track the position of the spectator display devices 106. The tracking system includes suitable positioning and tracking equipment, components or devices such as radio-frequency identification (RFID), wi-fi radios, local area network (LAN), wireless local area network (WLAN), wireless access point or hotspot, router, networked wireless detectors, digital camera, geotracking software, tracking algorithms, global positioning system (GPS), assisted global positioning system (AGPS), cellular towers, or other local positioning systems.

In one embodiment, display coordinates corresponding to a row and column seat number for one or more individual spectator positions 108, such as 8A, 8B, 8C, 9A, 9B, 9C, for example, create the array map. An example of such display coordinates that are used to create the display 100 includes display coordinates corresponding to seat numbers 18CC (seat corresponding to row 18, column CC, see FIG. 2), 19BB, 19CC, 20BB, 20CC, 21AA, 21BB, 22AA, 22BB, 23AA, 23BB, 24Z, 24AA, 24BB, 25Z, 25AA, 25BB, 26Y, 26Z, 26AA, 27Y, 27Z, 27AA, 28Y, 28Z, 28AA, 29X, 29Y, 29Z, 29AA, 30X, 30Y, 30Z, 30AA, 31W, 31X, 31Y, 31Z, 32W, 32X, 32Y, 32Z, 33V, 33W, 33X, 33Y, 33Z, 34V, 34W, 34X, 34Y, 34Z, 35U, 35V, 35W, 35X, 35Y, 36U, 36V, 36W, 36X, 36Y, 37U, 37V, 37W, 37X, 37Y, 37T, 38U, 38V, 38W, 38X, 39T, 39U, 39V, 39W, 39X, 40T, 40U, 40V, 40W, 40X, 41T, 41U, 41V, 41W, 41X, 42T, 42U, 42V, 42W, 42X, 43T, 43U, 43V, 43W, 43X, 44T, 44U, 44V, 44W, 44X, 45T, 45U, 45V, 45W, 45X, 46O, 46P, 46Q, 46R, 46S, 46T, 46U, 46V, 46W, 46X, 46Y, 46Z, 46AA, 46BB, 46CC, 47O, 47P, 47Q, 47R, 47S, 47T, 47U, 47V, 47W, 47X, 47Y, 47Z, 47AA, 47BB, 47CC, 48O, 48P, 48Q, 48R, 48S, 48T, 48U, 48V, 48W, 48X, 48Y, 48Z, 48AA, 48BB, 48CC, 49O, 49P, 49Q, 49R, 49S, 49T, 49U, 49V, 49W, 49X, 49Y, 49Z, 49AA, 49BB, 49CC, 50T, 50U, 50V, 50W, 50X, 51T, 51U, 51V, 51W, 51X, 52T, 52U, 52V, 52W, 52X, 53T, 53U, 53V, 53W, 53X, 54T, 54U, 54V, 54W, 54X, 55T, 55U, 55V, 55W, 55X, 56T, 56U, 56V, 56W, 56X, 57S, 57T, 57U, 57V, 57W, 57X, 58S, 58T, 59U, 59V, 59W, 59X, 59S, 59T, 59U, 59V, 59W, 59X, and 60U, 60V.

In one embodiment, the position detection of the spectator display devices 106 includes sensing input data corresponding to the device location, device orientation, and density of the devices 106 within a spectator region 102. The device location data corresponds to a relative position of the spectator display device 106 within the venue 104. The device orientation data includes information regarding whether the spectator display device 106 is in portrait or landscape orientation, or the angular orientation relative to a center point, for example, or a combination thereof. The device density data includes information identifying the number and spacing of available spectator display devices 106 within a given spectator region 102.

In one embodiment, the spectator display device 106 is configured to download a positioning software application or to access a venue website with a positioning link, for example, through an internet browser, mobile application, text message, or combination thereof. A suitable positioning software application enables a user to input the seat number of their spectator positions 108 into the spectator display device 106. A suitable venue website positioning link enables a user to input or confirm the seat number of their spectator positions 108. Other suitable positioning software applications utilize bar codes, for example, within the venue 104 and/or on credentials, such as tickets and/or any identifiable information and/or image on such credentials.

In one embodiment, the spectator display device 106 includes detection devices (for example, a digital camera, GPS sensor, AGPS software, or a combination thereof) to detect the location of the spectator device 106 that corresponds to a relative position within the venue 104. The camera communicates an image taken within the venue 104 to a suitable processing device, such as a remote server, for example. The remote server processes the venue image with image recognition software and/or algorithms to detect the relative position of the spectator display device 106 within the venue 104.

In one embodiment, the spectator display device 106 includes suitable motion sensing devices such as a digital electronic compass, an accelerometer, or a gyroscope, for example, or combinations thereof, that provide device orientation data. A suitable motion sensing device provides full nine degrees-of-freedom (DoF) motion sensing. In one embodiment, the spectator display device 106 includes a location controller that receives the device orientation data from the motion sensing devices. In one embodiment, the location controller provides the device orientation data to the tracking system.

In one embodiment, the tracking system is configured to provide image display optimization based upon the device orientation data, device location data, and device density data detected. For example, the tracking system includes feedback capabilities that detect irregular positions of the spectator display device 106 and modifies the image data transmitted, detects if an assigned spectator display device is not located in the corresponding spectator position, detects if a spectator position no longer has a spectator display device, detects if the spectator display device ceases functioning, detects if an assigned spectator display device is oriented at a improper angle relative to a focal point in the venue 104, detects if portions of the array map within the spectator region 102 have a low density or a high density of available spectator display devices 106, reprocesses and adjusts the image data provided in order to maintain the display image in spite of the irregularities, or a combination thereof.

The tracking system executes any suitable response in view of the detected condition. Suitable responses include, but are not limited to, (for example, if the assigned spectator display device is positioned slightly off from the position desired relative to the corresponding spectator position), adjusting the image data provided to that spectator display device in order to maintain the display image. In one embodiment, the response includes (for example, if a portion of the array map within the spectator region 102 has a low density detected), reprocessing and adjusting the image data provided to the spectator region 102 in order to maintain the display, providing less image data to the low density portion and more image data to the high density portion, providing image data only to the high density portion, providing image data to create a display 100 customized according to the density distribution within the spectator region 102, or combinations thereof.

The spectator region 102 is located in any suitable venue 104 and is an area capable of arranging people in a configuration desirable for viewing an event, such as a sporting or entertainment event. Examples include a sports stadium, concert, or other performance facility. The spectator region 102 is located in any suitable environment, such as outdoors, exposed to ambient conditions, indoors, underwater, or partially exposed, for example, or combinations thereof. In one embodiment, the individual spectator positions 108 are arranged and disposed within the spectator region 102 with the rows or seating positioned in any suitable arrangement, such as multi-level, staggered, tiered, curved, or single-level, for example, or combinations thereof.

The display 100 forms any suitable image. Suitable images include, but are not limited to, an illusion of a continuous image (for example, when viewed from a suitable distance within and/or beyond the venue 104), a suitable three-dimensional image, a landscape image, a portrait image, a text image, a text string image, or a combination thereof.

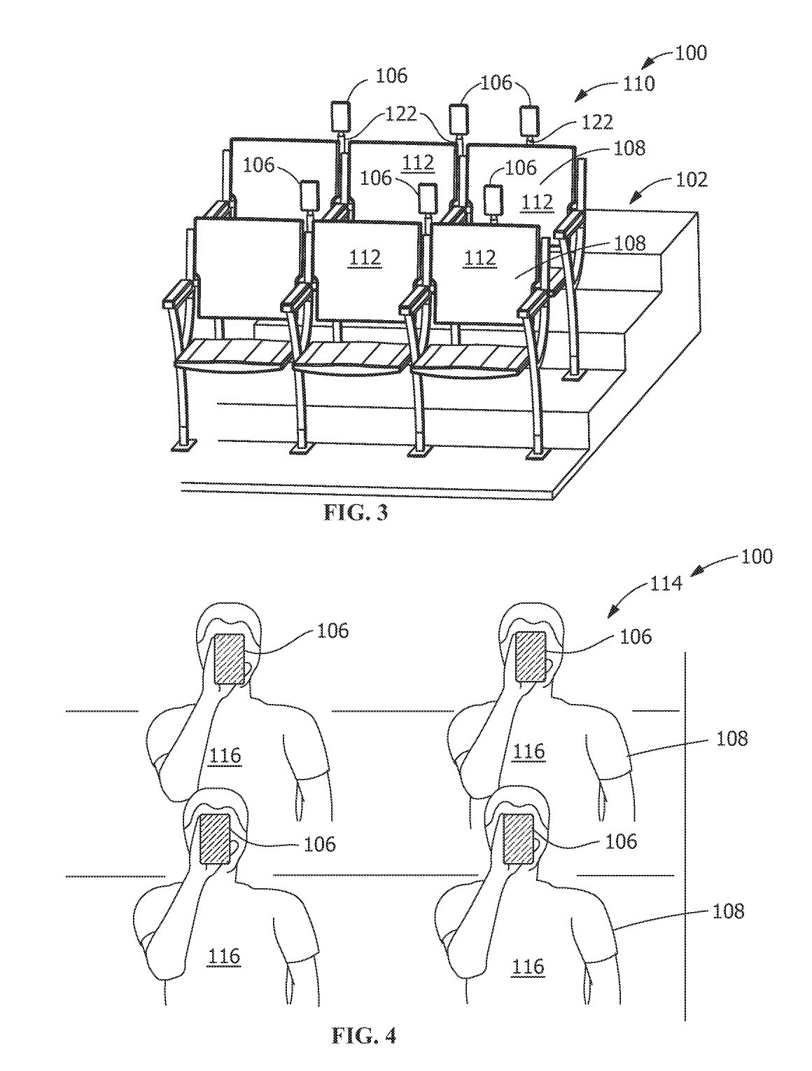

FIG. 3 shows an embodiment of the seat-mounted display 110 including a plurality of the spectator display devices 106. The seat-mounted display 110 includes the display devices 106 arranged and disposed on or adjacent to a seat 112 within the spectator region 102. Individual seats 112 correspond with the spectator position 108 display coordinates within the array map. The seat 112 includes features, such as a fastening device 122, (for example, a mounting sleeve, cradle, or clamp), to removably secure the spectator display device 106. The spectator display devices 106 are arranged a predetermined distance apart. The predetermined spacing includes up to three suitable parameters, such as x, y, and z, for example, the data corresponding to x as horizontal side-by-side distance, y as horizontal front-to-back distance, and z as vertical distance. The predetermined spacing is any suitable distance. Suitable distances are between about 20 inches to about 4 feet, between about 20 inches to about 3 feet, between about 20 inches to about 30 inches, between about 2 feet to about 3 feet, between about 3 feet to about 4 feet, or any suitable range, subrange, combination, or subcombination thereof, or the devices are abutting. In one embodiment, the predetermined spacing distance of the adjacent display devices is approximately the same distance as the center-to-center spacing of the adjacent seats 112 that the corresponding spectator display devices 106 are disposed on or adjacent to. In another embodiment, the predetermined spacing distance of the adjacent display devices is a different distance from the center-to-center spacing of the adjacent seats 112 that the corresponding spectator display devices 106 are disposed on or adjacent to.

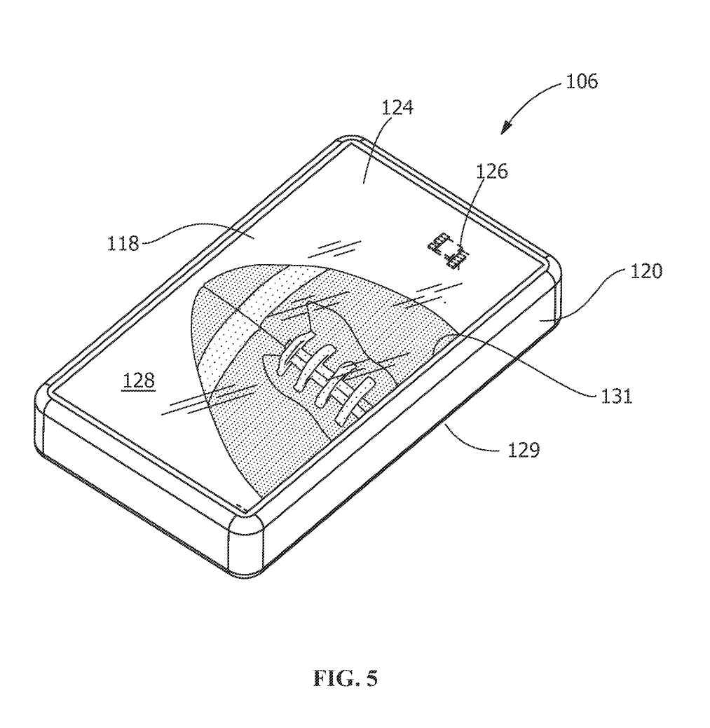

FIG. 4 shows an embodiment of the spectator-mounted display 114 including a plurality of the spectator display devices 106. The spectator-mounted display 114 includes the spectator display devices 106 arranged and disposed on or by a spectator 116 within the spectator region 102. The spectator display devices 106 are provided or distributed in the venue 104, provided as a promotional item prior to, or separate from an event, provided or owned by the spectator 116, or a combination thereof. In one embodiment, the spectator-mounted display 114 is formed by the spectator 116 holding the spectator display device 106 in a suitable viewable position, such as in front of their face, facing toward the center of the venue 104, for example. In one embodiment, the spectator-mounted display 114 is formed by the spectator 116 removably attaching or securing the spectator display device 106 to their person by suitable mounting, such as by headgear, or chest harness, for example, for a hands-free display.

The spectator-mounted display 114 fosters participation by the spectator 116. The spectator display devices 106 are mobile, configured to create the display 100 while in motion, receive instructions directing the spectator 116 to move to a predetermined location within the venue 102 at a predetermined time (for example, a flash mob in a concession area), receive instructions directing the spectator 116 to move and reposition their spectator display devices 106 in a sequence to create a suitable motion display 100 (for example, a wave, a sequence of choreographed movements, swaying, or any other movement), receive audio signals (for example, music that plays in sync with the image displayed), or any combination thereof.

Referring to FIG. 5, in one embodiment, the spectator display device 106 for creating a display 100 in a venue 104 includes a display portion 118 arranged and disposed in a housing 120. The display portion 118 includes one or more of light emitting elements 124 connected to the display portion 118 and/or a display controller 126 configured to control the light emitting elements 124. In one embodiment, the display controller 126 is an independently controlled addressable controller.

The spectator display device 106 includes any suitable mobile communication device (for example, a smart phone, cell phone, personal digital assistant, media player, tablet computer, notebook computer, or laptop computer) configured for wireless communication. In one embodiment, the spectator display devices 106 are powered from a local power source, such as one or more batteries arranged and disposed therein. In one embodiment, the spectator display devices 106 are mobile untethered units. As used herein, the phrase “mobile untethered” refers to not requiring a physical connection to external wiring or cable, for example, in order to receive or transmit power and/or data during operation. In one embodiment, the spectator display devices 106 are configured for plug-in connections to allow for optional physical connection to external wiring or cable, for example, in order to receive or transmit power or data. In one embodiment, the spectator display devices 106 are configured for plug-in connections, such as by USB, to allow for uploading of image data from a suitable secondary external portable device, such as a tablet computer.

In one embodiment, the display portion 118 includes a cover panel 128 having a suitable material to allow light transmission while providing protection to the light emitting elements 124. Suitable materials include, but are not limited to, a transparent polycarbonate with a scratch and UV resistant, antireflective coating, or any other suitable durable transparent or semi-transparent or semi-translucent material capable of supporting a predetermined structural load (as if sat or stepped upon, for example) and/or resisting cracking if dropped onto a concrete surface by a spectator 116. In one embodiment, the spectator display device 106 housing 120 is fabricated of a durable, moldable polymeric material, or any other suitable durable material capable of supporting a predetermined structural load and resisting impact fractures. In one embodiment, the spectator display device 106 includes a suitable resilient or elastomeric material to provide improved gripping and/or shock absorption.

The display portion 118 is substantially planar and includes a first side (for example, a front side 129) and a second side (for example, a rear side 131). Alternatively, the display portion 118 is any suitable shape or amorphous, such as with flexible materials. The spectator display device 106 is configured to display an image on both the front side 129 and the rear side 131, or on only the front side 129. In one embodiment, the spectator display device 106 is capable of displaying different images on the front side 129 and the rear side 131.

FIG. 6 shows an embodiment of a system 132 for creating a display 100. The system 132 includes a plurality of spectator display devices 106 provided with image data 134, for example, the system 132 includes a first spectator display device 106a and a second spectator display device 106b. At least a portion of the first spectator display device 106a is positioned within the spectator region 102 of the venue 104. In one embodiment, the spectator display device 106 is configured to receive image data 134, and at least one of the one or more light emitting elements 124 is capable of being activated based upon the image data 134. In one embodiment, the display controller 126 is preprogrammed with image data 134. In one embodiment, a composite image 136 is converted into the image data 134. In one embodiment, the image data 134 provided is real-time data from a live feed.

The spectator display device 106 is configured to activate at least one of the one or more light emitting elements 124, for example, based upon the image data 134 to display a partial image 138 or a sequence of partial images 138. In one embodiment, the spectator display device 106 is configured to display the partial image 138 in real-time or substantially real-time from a live feed, for example, with little or no image data manipulation, such as by interpolation, morphing, and/or dissolving. In one embodiment, the spectator display devices 106 are driven by any suitable image, such as still image, live image, predefined video, animated image, or interactive image, for example. The plurality of spectator display devices 106 are arranged and disposed in the array map whereby the partial images 138 produced are configured to form or create a substantially continuous display 100, providing an illusion of a continuous image.

The image data 134 is communicated by any suitable mechanism, such as, a remote controller 140. The remote controller 140 is capable of providing image data 134 to the spectator display devices 106, independently controlling the spectator display devices 106, operating with one or more other controllers, coordinating video or image displays (for example, a computer, computing device, or processor), is configured for transmission of a wireless communication signal, is operated by a predetermined operator (for example, a performer, a player, an announcer, a producer, or a designated spectator, such as a winner of a contest), or a combination thereof.

The spectator display devices 106 are connected to each other and/or the remote controller 140 by any suitable connection. Suitable connections include, but are not limited to, a wireless connection 142 or other communication and/or power transmitting device, for example, through an infrared (IR), radiofrequency (RF), other suitable wavelengths, cellular, 3G networks, 4G networks, or any other electromagnetic signal. In one embodiment, the stream of image data 134 is transmitted to all the spectator display devices 106 to provide the desired visual display 100. The addressable capability of the display controller 126 allows the individual spectator display devices 106 to receive and process the specific image data 134 transmitted for that corresponding device. The system 132 utilizes suitable software, hardware, video signals, image signals, controllers, media servers, control devices and electronics, and combinations thereof to generate, transmit, and process video and/or images for display of the partial images 138 through the spectator display devices 106.

The activation based upon the image data 134 includes various control functions. Suitable control functions include, but are not limited to, being capable of independently turning the display capability of the spectator display devices 106 on or off, independently controlling a level of intensity of the light emitting elements 124 (for example, to vary the brightness of light displayed), independently controlling the light emitting elements 124 (for example, to vary the color displayed by each of the light emitting elements), emitting multiple colors of light simultaneously or at different times, independently controlling activation sequences of the light emitting elements 124 (for example, to vary the duration and sequences of light displayed), controlling all of the one or more light emitting elements 124 simultaneously, controlling only a portion of the one or more light emitting elements 124, controlling the one or more light emitting elements 124 in coordination with an audio signal, controlling the one or more light emitting elements 124 or the display capability of the spectator display devices 106 with voice commands issued by the spectator 116, or any combination thereof. In one embodiment, the range of light intensity simultaneously displayed on one spectator display device 106 and/or specific portions of the spectator display devices 106 is between about 30 percent to about 100 percent, between about 30 percent to about 50 percent, or between about 60 percent to about 80 percent, or any suitable range therein.

In one embodiment, the composite image 136 is converted into the image data 134 through use of an interpolation rendering algorithm. In this embodiment, the composite image 136 (a three dimensional model in a vector graphics format, for example) is converted into a partial image in a two dimensional plane for output or for storage. In one embodiment, the rendering algorithm includes a perspective projection transformation utilizing a regenerated frustum as the intermediated form factor. In one embodiment, the interpolation rendering algorithm includes an interpolation scaling algorithm. The scaling algorithm is utilized to enlarge or scale up the image to create the display 100 in the desired venue 104, such as in a sports stadium or concert.

A process of creating a display 100 having an illusion of a continuous image includes providing image data 134 to a plurality of spectator display devices 106. For example, the process includes providing image data 134 to a first spectator display device 106a, the first spectator display device 106a having one or more light emitting elements 124, and providing image data 134 to a second spectator display device 106b. The process includes activating at least one of the one or more light emitting elements 124 based upon the image data 134. In one embodiment, the process includes converting the composite image 136 into the image data 134. In one embodiment, the process includes the spectator display devices 106 positioned within a spectator region of a venue 104 (see FIG. 1).

In one embodiment, the conversion of the composite image 136 into the image data 134 includes creating a fullscreen image having a plurality of partial images. In one embodiment, each partial image includes partial image data. The partial image data includes corresponding electronic properties such as position coordinates in a digital array grid, a predetermined color, and a predetermined intensity, for example. In one embodiment, the process further includes assigning all or a portion of the partial image data to corresponding all or a portion of the corresponding spectator position 108 display coordinates within the array map of the venue 104.

In one embodiment, the image data 134 used to form the partial image 138 takes into account the predetermined viewing angle of display 100 with respect to a surface or object, such as a stage, a performer, or an overhead blimp, for example. In one embodiment, the conversion of the composite image 136 into the image data 134 includes utilizing the coordinates of a focal object at the venue, such as a stage performer, for example, as the focal point for determining one or more viewing angles for the partial image 138.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process of creating a display having an illusion of a continuous image, the process comprising:
providing image data to a first spectator display device, the first spectator display device including one or more light emitting elements; and
providing image data to a second spectator display device; and
activating at least one of the one or more light emitting elements based upon the image data;
wherein the first spectator display device is a mobile untethered device positioned within a spectator region of a venue.

2. The process of claim 1, wherein the first spectator display device is independently controlled.

3. The process of claim 1, further comprising using a tracking system to electronically detect and track the position of the spectator display devices.

4. The process of claim 3, wherein the position detection of the spectator display devices includes sensing input data corresponding to the device location.

5. The process of claim 3, wherein the tracking system is configured to provide image display optimization based upon device orientation data detected.

6. The process of claim 3, wherein the tracking system is configured to provide image display optimization based upon device density data detected within the spectator region.

7. The process of claim 3, wherein the tracking system reprocesses and adjusts the image data provided in order to maintain the display.

8. The process of claim 1, wherein the image data is provided to create a display customized according to device density distribution within the spectator region.

9. The process of claim 1, wherein the light emitting elements include light emitting diodes.

10. The process of claim 1, wherein the image data is real-time data from a live feed.

11. The process of claim 1, wherein activating the light emitting elements displays a partial image or a sequence of partial images.

12. The process of claim 1, wherein the spectator display devices are configured to create the display while in motion.

13. The process of claim 1, wherein the spectator display devices are configured receive instructions directing spectators to move and reposition their spectator display devices in a sequence to create a suitable motion display.

14. The process of claim 1, wherein the display uses the coordinates of a focal object at the venue as a focal point for determining one or more view angles for a partial image.

15. The process of claim 1, wherein the process further includes creating partial image data having corresponding electronic properties including position in a digital array grid, a predetermined color, and a predetermined intensity.

16. The process of claim 1, wherein the process further includes creating an array map having display coordinates corresponding to one or more individual spectator positions.

17. The process of claim 1, wherein the process further comprises assigning all or a portion of partial image data to corresponding all or a portion of display coordinates.

18. The process of claim 1, wherein the spectator display devices are arranged and disposed on or by a spectator within the spectator region.

19. A system for creating a display having an illusion of a continuous image, the system comprising:
a first spectator display device, the first spectator display device being a mobile untethered device including one or more light emitting elements;
a second spectator display device; and
a controller capable of providing image data to one or both of the first spectator display device and the second spectator display device;
wherein at least one of the one or more light emitting elements is capable of being activated based upon the image data; and
wherein at least a portion of the first spectator display device is positioned within a spectator region of a venue.

20. A spectator display device for creating a display in a venue, the spectator display device comprising:
one or more light emitting elements capable of being activated upon receiving image data;
wherein the spectator display device is a mobile untethered device positioned within a spectator region of the venue;
wherein the image data corresponds with a portion of the display.
